(19) United States
(12) Patent Application Publication
(10) Pub. No.: US 2025/0388128 A1
(43) Pub. Date: Dec. 25, 2025

(54) A METHOD OF CONTROLLING AN ELECTRIC POWER SYSTEM

(71) Applicant: VOLVO TRUCK CORPORATION, Göteborg (SE)

(72) Inventors: Fredrik BLOMGREN, Hisings Kärra (SE); Arne ANDERSSON, Mölnlycke (SE)

(73) Assignee: VOLVO TRUCK CORPORATION, Göteborg (SE)

(21) Appl. No.: 18/877,680

(22) PCT Filed: Jul. 4, 2022
(86) PCT No.: PCT/EP2022/068419

§ 371 Date: Dec. 20, 2024

(51) Int. Cl. B60L 58/30; B60L 7/10; B60L 50/75; B60L 58/12; B60L 58/40; H01M 8/04537; H01M 8/04858; H01M 16/00

(52) U.S. Cl. CPC B60L 58/30; B60L 7/10; B60L 50/75; B60L 58/12; B60L 58/40; H01M 8/04626; H01M 8/04925; H01M 16/006; B60L 2240/64; B60L 2260/20; H01M 2220/20; H01M 2250/20; H01M 2250/402

(57) ABSTRACT

A computer implemented method controls an electric power system of a fuel cell electric vehicle (FCEV). The electric power system has an energy storage system and a fuel cell. The fuel cell is controlled to assume a power mode when arriving at a starting position of an upcoming road path when an electric energy consumption of the electric power system exceeds an electric energy capacity of the electric power system.

### TECHNICAL FIELD

The present invention relates to electric power systems comprising an energy storage system and a fuel cell. In particular, the invention relates to a method of controlling such electric power system. The invention also relates to a corresponding electric power system. The invention is applicable on so-called fuel cell electric vehicles (FCEV), in particular medium-and heavy duty FCEVs. Although the invention will be described with respect to a heavy duty FCEV in the form of a truck, the disclosure is not restricted to this particular vehicle, but may also be used in other FCEVs.

### BACKGROUND

Electrified propulsion of passenger cars is becoming a conventional solution to reduce the environmental effect caused by vehicles. Heavy-duty vehicles, such as trucks, are also continuously developed to be able to provide electrified propulsion. The electrified propulsion system comprises one or more electric machines operable to generate a propulsion torque on one or more wheels of the vehicle.

However, heavy duty vehicles require a large energy capacity of the batteries feeding electric power to the electric machines in order to provide a desirable vehicle operating range. The electric capacity of the batteries is thus a limiting factor for the heavy duty vehicles.

Using a fuel cell to generate electric power during operation of the vehicle is one approach to increase the operational range for the heavy duty vehicles. The electric power generated by the fuel cell can be fed directly to the battery/batteries, or fed directly to the electric machine propelling the vehicle. To reduce degradation of the fuel cell, the fuel cell should preferably be operated to generate low levels of electric power and ramping up and down should preferably be avoided. However, the FCEV should still be able to handle all types of operating condition and there is thus a desire to improve the operational control of the electric power systems of such FCEVs.

### SUMMARY

It is thus an object of the present disclosure to at least partially overcome the above described deficiencies.

According to a first aspect, there is provided a computer implemented method of controlling an electric power system of a fuel cell electric vehicle (FCEV), the electric power system being operatively controlled by a processing circuitry and comprises an energy storage system and a fuel cell, wherein the fuel cell is operable to assume a cruise mode in which the fuel cell generates electric power at a first power level, and a power mode in which the fuel cell generates electric power at a second power level, the second power level being higher than the first power level, the method comprising determining, by the processing circuitry, a road topology for an upcoming road path to be operated by the FCEV; determining, by the processing circuitry, an electric energy level of the energy storage system; determining, by the processing circuitry, an electric power level generatable by the fuel cell along the road path when the fuel cell assumes the cruise mode; determining, by the processing circuitry, an electric energy consumption of the electric power system based on the road topology for operating the FCEV along the upcoming road path; determining, by the processing circuitry, an electric energy capacity of the electric power system along the road path based on the electric energy level of the energy storage system and the electric power level generatable by the fuel cell when assuming the cruise mode; and controlling, by the processing circuitry, the fuel cell to assume the power mode when arriving at a starting position of the upcoming road path when the electric energy consumption of the electric power system exceeds the electric energy capacity of the electric power system.

The cruise mode and the power mode should thus be construed as two different operating modes of the fuel cell, wherein the fuel cell generates electric power at different levels. In detail, the fuel cell generates power at a relatively high power level when assuming the power mode, and generates power at a lower power level when assuming the cruise mode. The cruise mode should be construed as the “sweet spot” for the fuel cell, i.e. the fuel cell is operated to generate electric power level at which a degradation rate of the fuel is kept at a minimum. The fuel cell should thus preferably be operated as much as possible to assume the cruise mode. According to a non-limiting example, the fuel cell generates electric power centered at approximately 100 kW when assuming the cruise mode, and generates electric power centered at approximately 300 kW when assuming the power mode. Thus a multiple integer of three. These are mere examples and should hence not be construed as limiting to the functionality of the present invention. Also, the cruise mode as well as the power mode should not be construed as fixed power levels. Rather, the cruise mode is a mode at which the fuel cell generates electric power at a first range, and the power mode is a mode at which the fuel cell generates electric power at a second range, which second range is at a higher electric power level compared to the first range. Preferably, the electric power level at a lower end of the second range is higher than the electric power level at an upper level of the first range.

The road topology should in this context be construed as a variation of uphill slopes and downhill slopes of the upcoming road path. The upcoming road path may thus comprise one or more uphill slopes of various angles and lengths, as well as one or more downhill slopes of various angles and lengths.

The present invention is based on the insight that the fuel cell should be operated in the cruise mode as much as possible, but should the fuel cell need to assume the power mode for the electric power system to manage an upcoming road path without draining the energy storage system, it is advantageous to switch to the power mode before entering the upcoming road path then to switch to the power mode during the operation along the road path. Thus, the invention advantageously determines beforehand that the electric power system will be unable to operate the upcoming road path by controlling the fuel cell to assume the cruise mode, and thus switches the fuel cell to assume the power mode directly, and not when it is determined that the energy storage system is about to drain from electric energy. Accordingly, and according to an example embodiment, the electric energy level of the energy storage system may be determined for the starting position of the upcoming road path. However, the electric energy level at the starting position can be estimated before arriving at the starting position.

It should thus be construed that the switching from the cruise mode to the power mode is not based on managing a steep uphill slope, i.e. to add additional power to the electric power system for a short period of time, but rather for the electric power system to manage the upcoming road path without draining the energy storage system and risk ending up along the road path with no electric energy available for further operation.

According to an example embodiment, the method may further comprise estimating, by the processing circuitry, a variation of a state of charge level of the energy storage system along the upcoming road path when the fuel cell assumes the cruise mode, and controlling, by the processing circuit, the fuel cell to assume the power mode when arriving at the starting position when the state of charge level of the energy storage system is determined to fall below a predetermined threshold limit along the upcoming road path by operating the fuel cell to assume the cruise mode.

The variation of state charge level can be based on the number and inclination of the upward slopes and downhill slopes along the upcoming road path. Hereby, it can be determined at which downhill sections, and to what degree, the energy storage system can be charged with electric power generated by an electric traction motor(s) of the FCEV during braking, as well as which uphill sections, and to what degree, the energy storage system feeds electric power to the electric traction motor(s).

Hence, should the state of charge level fall below the predetermined threshold limit at any positions along the road path, the fuel cell is preferably operated to assume the power mode along the entire road path.

Accordingly, and according to an example embodiment, the FCEV may comprise an electric traction motor configured to receive electric power from the electric power system during propulsion, and to feed electric power to the energy storage system generated by the electric traction motor during braking, wherein the electric energy capacity of the electric power system is further based on electric power generated by the electric traction motor along the upcoming road path.

According to an example embodiment, the processing circuitry may control the fuel cell to assume the power mode along the entire upcoming road path from the starting position to an end position when the electric energy consumption of the electric power system is determined to exceed the electric energy capacity of the electric power system.

According to an example embodiment, the method may further comprise controlling, by the processing circuitry, the fuel cell to assume the cruise mode when the electric energy consumption of the electric power system falls below the electric energy capacity of the electric power system. As indicated above, the degradation rate of the fuel cell is hereby reduced, and the operational lifetime of the fuel cell is increased.

According to an example embodiment, the method may further comprise dividing, by the processing circuitry, the upcoming road path into a plurality of road path sections, each road path section being associated with an individual road topology; wherein the electric energy consumption of the electric power system is determined for each road path section. By dividing the road path into the plurality of road path sections, the computational effort to estimate the electric energy consumption along the entire road trip is reduced compared to an estimation of the electric energy consumption along the entire road path. Accordingly, and according to an example embodiment, the electric energy capacity of the electric power system may be determined for each road path section. The processing circuitry can hereby determine if the electric energy consumption of the electric power system will exceed the electric energy capacity of the electric power system for each road path section.

According to an example embodiment, the electric energy level of the energy storage system may be determined at a start location of each road path sections. Preferably, and according to an example embodiment, the method may further comprise setting, by the processing circuitry, a desired state of charge level of the energy storage system at an end position of the upcoming road path; determining, by the processing circuitry, a desired electric energy capacity of the electric power system for each road path sections to arrive at the end position with the desired state of charge level of the energy storage system; and controlling, by the processing circuitry, the fuel cell to assume the power mode when arriving at a starting position of the upcoming road path when the determined electric energy capacity for a road path section is below the desired electric energy capacity for that road path section.

A backwards calculation is thus made based on the desired state of charge level at the end position of the upcoming road path. Hence, the FCEV should not only be able to be operated without draining the energy storage system, but also to arrive at the end position with the desired state of charge level. Should the processing circuitry determine that this is not possible by controlling the fuel cell to assume the cruise mode, the fuel cell should be controlled to assume the power mode throughout the entire upcoming road path, i.e. for each road path sections, until arriving at the end position.

According to a second aspect, there is provided an electric power system electrically connectable to an electric traction motor of a fuel cell electric vehicle (FCEV), the electric power system comprising an energy storage system and a fuel cell, wherein the fuel cell is operable to assume a cruise mode in which the fuel cell generates electric power at a first power level, and a power mode in which the fuel cell generates electric power at a second power level, the second power level being higher than the first power level, wherein the electric power system further comprises a control unit comprising processing circuitry operable to control the energy storage system and the fuel cell, the processing circuitry being configured to determine a road topology for an upcoming road path to be operated by the FCEV; determine an electric energy level of the energy storage system; determine an electric power level generatable by the fuel cell along the road path when the fuel cell assumes the cruise mode; determine an electric energy consumption of the electric power system based on the road topology for operating the FCEV along the upcoming road path; determine an electric energy capacity of the electric power system along the road path based on the electric energy level of the energy storage system and the electric power level generatable by the fuel cell when assuming the cruise mode; and control the fuel cell to assume the power mode when arriving at a starting position of the upcoming road path when the electric energy consumption of the electric power system exceeds the electric energy capacity of the electric power system.

The control unit may include a microprocessor, microcontroller, programmable digital signal processor or another programmable device. The control unit may also, or instead, include an application specific integrated circuit, a programmable gate array or programmable array logic, a programmable logic device, or a digital signal processor. Where the control unit includes a programmable device such as the microprocessor, microcontroller or programmable digital signal processor mentioned above, the processor may further include computer executable code that controls operation of the programmable device.

The expression “processing circuitry” as used above should be understood to include any type of computing device, such as an ASIC, a micro-processor, etc. It should also be understood that the actual implementation of such a processing circuitry may be divided between more than a single device/circuit.

Effects and features of the second aspect are largely analogous to those described above in relation to the first aspect.

According to a third aspect, there is provided a vehicle comprising a system according to the second aspect.

According to a fourth aspect, there is provided a computer program comprising program code means for performing the method of any of the embodiments described above in relation to the first aspect when the program is run on a computer.

According to a fifth aspect, there is provided a non-transitory computer readable medium carrying a computer program comprising program code for performing the method of any of the embodiments described above in relation to the first aspect when the program product is run on a computer.

According to a sixth aspect, there is provided a control unit for controlling an auxiliary system of a transportation vehicle, the control unit being configured to perform the method according to any of the embodiments described above in relation to the first aspect.

Effects and features of the third, fourth, fifth and sixth aspects are largely analogous to those described above in relation to the first aspect.

Further features of, and advantages with, the present disclosure will become apparent when studying the appended claims and the following description. The skilled person realizes that different features of the present disclosure may be combined to create examples other than those described in the following, without departing from the scope of the present disclosure.

### BRIEF DESCRIPTION OF THE DRAWINGS

The above, as well as additional objects, features, and advantages of the present disclosure, will be better understood through the following illustrative and non-limiting detailed description of exemplary examples of the present disclosure, wherein:

FIG. 1 is lateral side view of a fuel cell electric vehicle (FCEV) in the form of a truck according to an example embodiment,

FIG. 2 is a schematic illustration of an upcoming road path operable by the FCEV according to an example embodiment,

FIG. 3 is a schematic illustration of an electric power system of the FCEV according to an example embodiment; and

FIG. 4 is a flow chart of a method of controlling the electric power system according to an example embodiment.

### DETAIL DESCRIPTION

The present disclosure will now be described more fully hereinafter with reference to the accompanying drawings, in which exemplary examples are shown. The disclosure may, however, be embodied in many different forms and should not be construed as limited to the examples set forth herein; rather, these examples are provided for thoroughness and completeness. Like reference character refer to like elements throughout the description.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

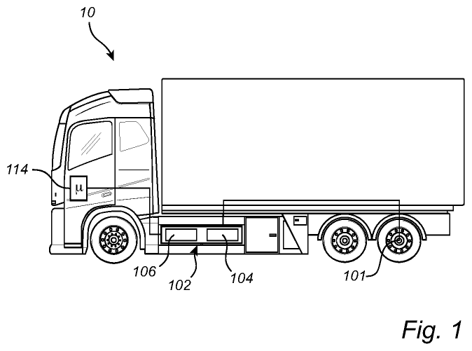

With particular reference to FIG. 1, there is depicted a fuel cell electric vehicle (FCEV) 10 in the form of a truck. The FCEV 10 will in the following merely be referred to as a vehicle and comprises an electric traction motor 101 for propelling the wheels of the vehicle. The electric traction motor 101 is in the example embodiment arranged in the form of an electric machine. The electric traction motor 101 is arranged to receive electric power from an electric power system 102 during propulsion, and to feed electric power generated by the electric machine 101 during braking to an energy storage system 104 of the electric power system. The energy storage system 104 is preferably a high voltage battery of the vehicle 10. As will be evident from the below disclosure, in particular in relation to FIG. 5, the electric power system 102 also comprises a fuel cell 106 electrically connected to the energy storage system 104. The fuel cell 106 is configured to generate electric power upon receiving hydrogen fuel and oxygen.

The vehicle 10 also comprises a control unit 114 connected to the electric power system 102 for controlling operation thereof. The control unit 114 may include a microprocessor, microcontroller, programmable digital signal processor or another programmable device. The control unit may also, or instead, include an application specific integrated circuit, a programmable gate array or programmable array logic, a programmable logic device, or a digital signal processor. Where the control unit 114 includes a programmable device such as the microprocessor, microcontroller or programmable digital signal processor mentioned above, the processor may further include computer executable code that controls operation of the programmable device.

During propulsion of the vehicle 10, electric power is generated by the fuel cell 106, which electric power is fed to the energy storage system 104, thereby charging the energy storage system 104 with electric energy. The energy generated by the fuel cell 106 may also be fed directly to the electric traction motor 101 during propulsion. Electric power is also preferably fed from the energy storage system 104 to the electric traction motor 101 during propulsion. Thus, when propelling the vehicle 10, the energy storage system 10 is steadily drained from electric energy which is consumed by the electric traction motor 101.

The fuel cell 106 is operable to assume a cruise mode in which the fuel cell generates electric power at a first power level. When operable in the cruise mode, the fuel cell 106 generates electric power in a power range between e.g. 70-130 kW, more preferably between 85-115 kW, and most preferably around approximately 100 kW. The fuel cell 106 is also operable to assume a power mode in which the fuel cell 106 generates electric power at a second power level. The second power level is higher than the first power level, and according to example, the second power level may be in the range between e.g. 250-350 kW, more preferably between 275-325 kW, and most preferably around approximately 300 kW.

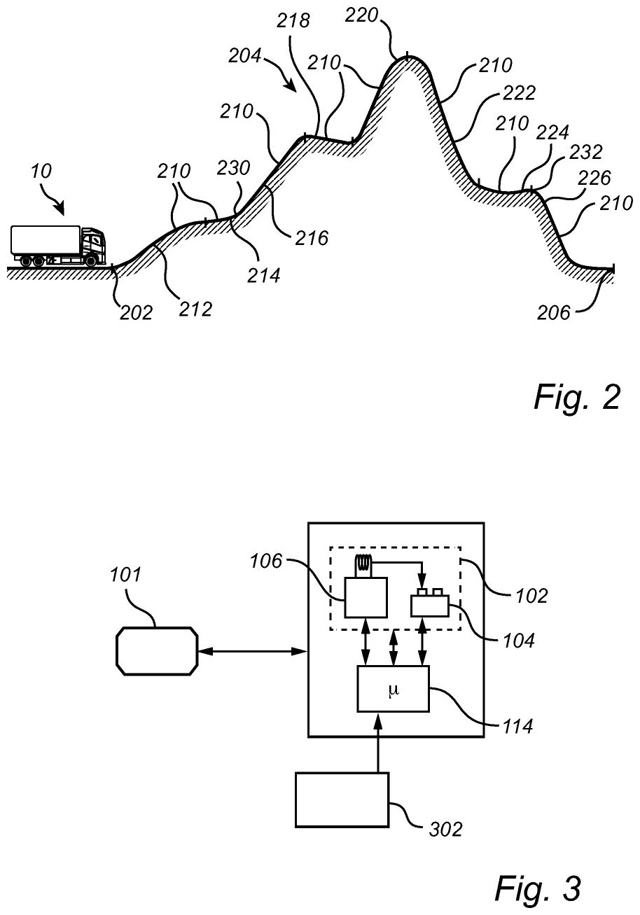

In order to reduce the degradation of the fuel cell 106, the fuel cell 106 should preferably be operated in the cruise mode as much as possible, However, there are operating conditions at which the electric energy of the energy storage system 104 in combination with the electric power generated by the fuel cell 106 when assuming the cruise mode is not sufficient to fulfil an intended mission. Put it differently, the electric machine 101 may require such high level of electric energy for an upcoming road path that the energy storage system 104 will be drained from electric energy when operating the fuel cell 106 to assume the cruise mode. In such situations, the fuel cell 106 may be switched to assume the power mode. Reference is now made to FIG. 2 for describing example embodiments of switching to the power mode in a manner reducing the degradation of the fuel cell 106.

As can be seen in FIG. 2, the vehicle 10 is located at a starting position 202 and about to be operated at an upcoming road path 204. The upcoming road path 204 comprises a number of uphill slopes as well as a number of downhill slopes. The state of charge level of the energy storage system 104 may thus vary along the road path depending on the number, length and inclination of the uphill and downhill slopes, as well as the vehicle speed during the road path. The processing circuitry of the control unit 114 hereby, before initiating the mission from the starting position 202 to an end position 206 of the upcoming road path 204, determines a road topology 208 of the upcoming road path 204. The road topology 208 may be determined based on map data from e.g. a GPS or the like arranged in communication with the control unit.

In addition, the electric energy level, i.e. the state of charge (SoC) level of the energy storage system 104 is determined before the mission. Moreover, the processing circuitry further determines an electric power level generatable by the fuel cell 106 during operation from the starting position 202 to the end position 206 when the fuel cell 106 assumes the cruise mode. An electric energy capacity of the electric power system 102 along the road path 204 can hereby be determined based on the electric energy level of the energy storage system 104 and the electric power level generatable by the fuel cell 106 when assuming the cruise mode. Put it differently, the processing circuitry can determine the electric energy level available for the electric machine 101 when the vehicle 10 is operated along the road path 204.

Still further, an electric energy consumption of the electric power system 102 is determined based on the road topology 204. Hence, the processing circuitry determines how much electric energy being consumed by the electric machine 101 for operating the vehicle 10 along the upcoming road path. For example, the processing circuitry can determine the level of electric power fed to the electric machine 101 for properly propelling the vehicle along the uphill slopes, as well as the level of electric power generated by the electric machine 101 during braking in the downhill slopes.

When the processing circuitry determines that the electric energy consumption of the electric power system 102 will exceed the electric energy capacity of the electric power system 102 somewhere along the road path 204 if the fuel cell 106 assumes the cruise mode, the processing circuitry controls the fuel cell 106 to assume the power mode before the vehicle leaves the starting position 202 and initiates the journey along the road path 204. Accordingly, the fuel cell 106 is switched to assume the power mode for the entire road path from the starting position 202 to the end position 206 and the risk of draining the energy storage system 104 along the road path 204 is reduced. The inventors have also unexpectedly realized that the degradation level of the fuel cell 106 is reduced if switching to the power mode before the vehicle 10 leaves the starting position 202 compared to switching to the power mode first at a point in time when the energy storage system 104 is drained, or determined to soon be drained.

However, should the processing circuitry determine that the electric energy consumption of the electric power system 102 will be below, or fall below, the electric energy capacity of the electric power system 102, the fuel cell 106 is controlled to assume the cruise mode during the entire road path 204 from the starting position 202 to the end position 206.

As exemplified in FIG. 2, the upcoming road path 204 may advantageously be divided into a plurality of road path sections 210. In FIG. 2, the upcoming road path 204 is divided into a first 212, a second 214, a third 216, a fourth 218, a fifth 220, a sixth 222, a seventh 224 and an eighth 226 road path section. Each road path section 210 is associated with an individual road topology, i.e. the processing circuitry determines the length and inclination for each road path section 210, whereby the electric energy consumption of the electric power system 102 for each of these road path sections 210 can be determined. In addition, also the electric energy capacity of the electric power system can be determined for each road path section 210.

Moreover, the processing circuitry may also set a desired state of charge level of the energy storage system 104 at the end position of the upcoming road path 204. Further, a desired electric energy capacity of the electric power system for each road path sections 210 can be determined for arriving at the end position with the desired state of charge level. The processing circuitry may hereby control the fuel cell to assume the power mode when arriving at the starting position 202 of the upcoming road path 204 when the determined electric energy capacity for at least one of the road path section 210 is below the desired electric energy capacity for that road path section.

Furthermore, the electric energy level of the energy storage system 104 is preferably determined at a start location of each road path sections. According to the exemplified embodiment depicted in FIG. 2, the electric energy level of the third road path section 216 is determined at the start location 230 of that road path section, i.e. at the position between the second 214 and third 216 road path sections.

According to the example in FIG. 2, when determining the desired state of charge level at the end position 206, a desired electric energy capacity of the electric power system 102 is determined for the eighth road path section 226. A desired state of charge level at the start location 232 of the eighth road path section 226 can hereby be determined. Thereafter, a desired electric energy capacity of the electric power system 102 is determined for the seventh road path section 224 based on the desired state of charge level at the start location 232 of the eighth road path section 226. The electric power system 102 can hereby be controlled from the starting position 202 and for each road path section 210 to arrive at the end position 206 with the desired state of charge level, and to control the fuel cell 106 to assume the power mode when the vehicle 10 is located at the starting position 202 if the electric energy capacity is insufficient to properly operate the vehicle to arrive at the end position for any one of the road path sections 210.

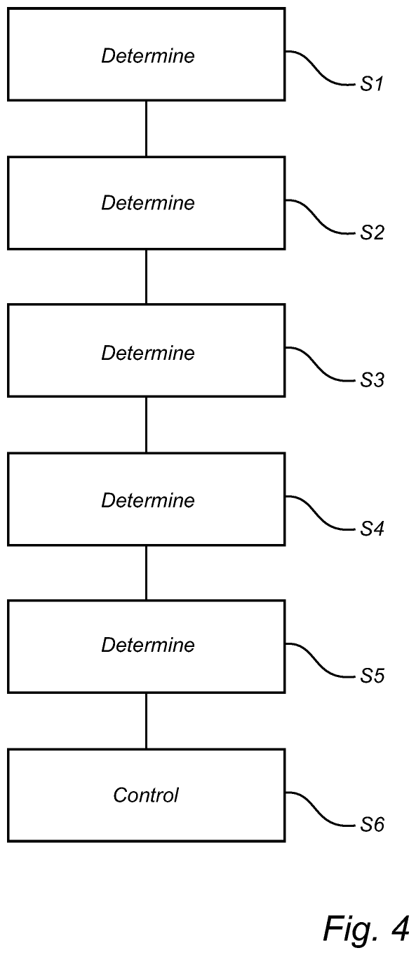

Reference is now finally made to FIGS. 3 and 4 for describing the electric power system 102 and the method of controlling the electric power system in further detail. During operation, a road topology 208 for an upcoming road path 204 to be operated by the vehicle 10 is determined S1. Also, an electric energy level of the energy storage system 104 is determined S2.

Moreover, the electric power level generatable by the fuel cell 106 when the vehicle is operated along the road path 204 with the fuel cell 106 assuming the cruise mode is determined S3. Also, based on the road topology 208, an electric energy consumption of the electric power system 102 can be determined S4, and the electric energy capacity of the electric power system 102 along the road path 208 is determined S5 based on the electric energy level of the energy storage system 102 and the electric power level generatable by the fuel cell 106 when assuming the cruise mode.

If it thereafter is determined that the electric energy consumption of the electric power system exceeds the electric energy capacity of the electric power system when the vehicle 10 is operated along the road path 204 with the fuel cell 106 assuming the cruise mode, the processing circuitry controls S6 the fuel cell 106 to assume the power mode already before leaving the starting position 202.

It is to be understood that the present disclosure is not limited to the examples described above and illustrated in the drawings; rather, the skilled person will recognize that many changes and modifications may be made within the scope of the appended claims.

1. A computer implemented method of controlling an electric power system of a fuel cell electric vehicle, FCEV, the electric power system being operatively controlled by a processing circuitry and comprises an energy storage system and a fuel cell, wherein the fuel cell is operable to assume a cruise mode in which the fuel cell generates electric power at a first power level, and a power mode in which the fuel cell generates electric power at a second power level, the second power level being higher than the first power level, the method comprising:
determining, by the processing circuitry, a road topology for an upcoming road path to be operated by the FCEV;
determining, by the processing circuitry, an electric energy level of the energy storage system;
determining, by the processing circuitry, an electric power level generatable by the fuel cell along the road path from a starting position to an end position when the fuel cell assumes the cruise mode;
determining, by the processing circuitry, an electric energy consumption of the electric power system based on the road topology for operating the FCEV along the upcoming road path;
determining, by the processing circuitry, an electric energy capacity of the electric power system along the road path based on the electric energy level of the energy storage system and the electric power level generatable by the fuel cell when assuming the cruise mode; and
controlling, by the processing circuitry, the fuel cell to assume the power mode when arriving at a starting position and for the entire road path from the starting position to the end position of the upcoming road path when the electric energy consumption of the electric power system exceeds the electric energy capacity of the electric power system.

2. The computer implemented method according to claim 1, wherein the electric energy level of the energy storage system is determined for the starting position of the upcoming road path.

3. The computer implemented method according to claim 1, further comprising:
estimating, by the processing circuitry, a variation of a state of charge level of the energy storage system along the upcoming road path when the fuel cell assumes the cruise mode, and
controlling, by the processing circuit, the fuel cell to assume the power mode when arriving at the starting position when the state of charge level of the energy storage system is determined to fall below a predetermined threshold limit along the upcoming road path by operating the fuel cell to assume the cruise mode.

4. The computer implemented method according to claim 1, wherein the FCEV comprises an electric traction motor configured to receive electric power from the electric power system during propulsion, and to feed electric power to the energy storage system generated by the electric traction motor during braking, wherein the electric energy capacity of the electric power system is further based on electric power generated by the electric traction motor along the upcoming road path.

5. The computer implemented method according to claim 1, wherein the processing circuitry controls the fuel cell to assume the power mode along the entire upcoming road path from the starting position to the end position when the electric energy consumption of the electric power system is determined to exceed the electric energy capacity of the electric power system.

6. The computer implemented method according to claim 1, further comprising:
controlling, by the processing circuitry, the fuel cell to assume the cruise mode when the electric energy consumption of the electric power system falls below the electric energy capacity of the electric power system.

7. The computer implemented method according to claim 1, further comprising:
dividing, by the processing circuitry, the upcoming road path into a plurality of road path sections, each road path section being associated with an individual road topology;
wherein the electric energy consumption of the electric power system is determined for each road path section.

8. The computer implemented method according to claim 7, wherein the electric energy capacity of the electric power system is determined for each road path section.

9. The computer implemented method according to claim 8, wherein the electric energy level of the energy storage system is determined at a start location of each road path sections.

10. The computer implemented method according to claim 8, further comprising:
setting, by the processing circuitry, a desired state of charge level of the energy storage system at an end position of the upcoming road path;
determining, by the processing circuitry, a desired electric energy capacity of the electric power system for each road path sections to arrive at the end position with the desired state of charge level of the energy storage system; and
controlling, by the processing circuitry, the fuel cell to assume the power mode when arriving at a starting position of the upcoming road path when the determined electric energy capacity for a road path section is below the desired electric energy capacity for that road path section.

11. An electric power system electrically connectable to an electric traction motor of a fuel cell electric vehicle, FCEV, the electric power system comprising an energy storage system and a fuel cell, wherein the fuel cell is operable to assume a cruise mode in which the fuel cell generates electric power at a first power level, and a power mode in which the fuel cell generates electric power at a second power level, the second power level being higher than the first power level, wherein the electric power system further comprises a control unit comprising processing circuitry operable to control the energy storage system and the fuel cell, the processing circuitry being configured to:
determine a road topology for an upcoming road path to be operated by the FCEV;
determine an electric energy level of the energy storage system;
determine an electric power level generatable by the fuel cell along the road path from a starting position to an end position when the fuel cell assumes the cruise mode;
determine an electric energy consumption of the electric power system based on the road topology for operating the FCEV along the upcoming road path;
determine an electric energy capacity of the electric power system along the road path based on the electric energy level of the energy storage system and the electric power level generatable by the fuel cell when assuming the cruise mode; and
control the fuel cell to assume the power mode when arriving at a starting position and for the entire road path from the starting position to the end position of the upcoming road path when the electric energy consumption of the electric power system exceeds the electric energy capacity of the electric power system.

12. A vehicle comprising a system according to claim 11.

13. A computer program comprising program code means for performing the method of claim 1 when the program is run on a computer.

14. A non-transitory computer readable medium carrying a computer program comprising program code for performing the method of claim 1 when the program product is run on a computer.

15. A control unit for controlling an auxiliary system of a transportation vehicle, the control unit being configured to perform the method according to claim 1.
